(19) United States
(12) Patent Application Publication
(10) Pub. No.: US 2009/0054039 A1
(43) Pub. Date: Feb. 26, 2009

(54) Methods and Systems for Presence-Based Filtering of Notifications of Newly-Received Personal Information Manager Data

(76) Inventors: Jacques van Wijk, Scheveningen (NL); Johan Philip Weyer, Amsterdam (NL)

Correspondence Address: CHOATE, HALL & STEWART LLP, TWO INTERNATIONAL PLACE, BOSTON, MA, 02110, US

(21) Appl. No.: 12/035,119

(22) Filed: Feb. 21, 2008

Related U.S. Application Data
(60) Provisional application No. 60/890,944, filed on Feb. 21, 2007.

(51) Int. Cl. H04M 1/725

(52) U.S. Cl. 455/412.1

(57) ABSTRACT

A system for transmitting, to a mobile device, a notification of newly-received personal information manager data associated with a user of the mobile device, responsive to presence-based filtering, includes a notification agent, a presence agent, a notification service, and a communications agent. The notification agent receives an identification of data received for a user of a personal information manager. The presence agent provides presence-related data associated with the user. The notification service, in communication with the notification agent and with the presence agent, applies a filter to presence-related data and generates a message including the identification of the received data, responsive to the application of the filter to the received presence-related data. The communications agent transmits the generated message to a mobile device associated with the user.

### RELATED APPLICATIONS

The present application claims priority to U.S. Provisional Patent Application Ser. No. 60/890,944, entitled “Systems and Methods for Providing Notifications” filed Feb. 21, 2007, which is incorporated herein by reference.

### FIELD OF THE INVENTION

The present disclosure relates to methods and systems for managing data. In particular, the present disclosure relates to methods and systems for presence-based filtering of notifications of newly-received personal information manager data.

### BACKGROUND OF THE INVENTION

There are various mechanisms that provide “push” type notification of personal information management (PIM) data for mobile devices. One popular example is the BLACKBERRY push technology for delivering data to a device in the BLACKBERRY line of devices sold by Research in Motion of Waterloo, Ontario, Canada. Typically, when a new mail message, calendar event or other PIM data arrives at a back-end server, that data is forwarded (e.g., “pushed”) to the BLACKBERRY device. Other services, such as VISTO MOBILE provided by Visto Corporation of Redwood City, Calif., and those provided by SEVEN Networks of Redwood City, Calif., also provide “push” and scheduled “pull” type personal information services. Another service that provides “push” type PIM information is the INTELLISYNC MOBILE SUITE offered by Nokia of Finland. However, in many environments, such as large corporate enterprises, a large amount of data may be frequently pushed to the user device. Given the power and storage constraints of typical mobile devices, receiving these large amounts of data may overload the mobile device. Some services provide users with limited configuration abilities to specify the frequency of when a push occurs. Conventionally, however, these services do not consider the detailed preferences of the user or the capabilities of the mobile device in determining whether to notify the user of the arrival of the data.

### BRIEF SUMMARY OF THE INVENTION

In one aspect, a method for transmitting, to a mobile device, a notification of newly-received personal information manager data associated with a user of the mobile device, responsive to presence-based filtering, includes the step of transmitting, by a notification agent, to a notification service, an identification of data received for a user of a personal information manager. The method includes the step of requesting, by the notification service, from a presence agent, presence-related data associated with the user. The method includes the step of applying, by the notification service, a filter to the received presence-related data. The method includes the step of transmitting, by a communications agent, to a mobile device associated with the user, a notification of the receipt of data, responsive to the application of the filter to the presence-related data.

In one embodiment, the notification service requests, from the presence agent, an indication of a location in which the user is physically present. In another embodiment, the notification service requests, from the presence agent, an identification of a time zone of a location in which the user is present at a time when the notification service receives the identification of the received data. In still another embodiment, the notification service requests, from the presence agent, an identification of an itinerary associated with the user at a time when the notification service receives the identification of the received data. In yet another embodiment, the notification service requests, from the presence agent, an indication of whether a mobile device associated with the user is connected to a network.

In one embodiment, the notification service requests, from the presence agent, an indication of whether the user is connected to a client machine associated with the user. In another embodiment, the notification service requests, from the presence agent, an indication of a level of activity on a client machine associated with the user. In still another embodiment, the notification service requests, from the presence agent, an indication of whether the user is connected to an instant messaging service. In yet another embodiment, the notification service requests, from the presence agent, an indication of a level of activity of the user on an instant messaging service.

In one embodiment, the notification service determines not to notify the user of the receipt of the identified data, responsive to the application of the filter to the presence-related data. In another embodiment, the communications agent transmits, via short message service, the notification of the receipt of data, responsive to the application of the filter to the presence-related data. In still another embodiment, the communications agent transmits, via multimedia message service, the notification of the receipt of data, responsive to the application of the filter to the presence-related data. In yet another embodiment, the communications agent transmits, the notification of the receipt of data, responsive to the application of the filter to the presence-related data, the notification formatted to comply with a display requirement of the mobile device.

In another aspect, a system for transmitting, to a mobile device, a notification of newly-received personal information manager data associated with a user of the mobile device, responsive to presence-based filtering, includes a notification agent, a presence agent, a notification service, and a communications agent. The notification agent receives an identification of data received for a user of a personal information manager. The presence agent provides presence-related data associated with the user. The notification service, in communication with the notification agent and with the presence agent, applies a filter to presence-related data and generates a message including the identification of the received data, responsive to the application of the filter to the received presence-related data. The communications agent transmits the generated message to a mobile device associated with the user. In one embodiment, the presence agent includes a global positioning system transceiver identifying a physical location of the user. In another embodiment, the presence agent includes a localization-based system identifying a physical location of the mobile device associated with the user.

In some embodiments, the system includes an event generator in communication with the notification agent and transmitting, to the notification service, the identification of received data. In other embodiments, the system includes a storage element storing a copy of the received data. In still other embodiments, the system includes a wireless application protocol server transmitting a server-alerted synchronization message to the mobile device, responsive to the application of the filter to the presence-related data.

In one embodiment, the presence agent includes a transceiver for requesting an activity status of a client machine associated with the user. In another embodiment, the presence agent includes a transceiver for requesting a connectivity status of a client machine associated with the user. In still another embodiment, the presence agent includes a transceiver for requesting an activity status of an instant messaging account associated with the user. In yet another embodiment, the presence agent includes a transceiver for requesting a connectivity status of a mobile device associated with the user.

In another aspect, a system for transmitting, to a mobile device, a consolidated notification of updated personal information manager data associated with a user of the mobile device includes a notification agent, a notification service and a communications agent. The notification agent receives a first identification of received event data associated with a user of a personal information manager. The notification service receives the first identification of received event data, delays transmission to the user of the first notification of the identification of received event data, receives a second identification of received event data, determines that the second identification of received event data and the first identification of received event data relate to a single event, and selects one of the second identification of received event data and the first identification of received event data after the predetermined period of time elapses. The communications agent transmits, to a mobile device associated with the user, a notification of the selected identification of received event data.

In still another aspect, a method for transmitting, to a mobile device, a consolidated notification of updated personal information manager data associated with a user of the mobile device includes the step of transmitting, by a notification agent, to a notification service, a first identification of received event data associated with a user of a personal information manager. The method includes the step of delaying, by the notification service, for a predetermined period of time, transmission to the user of a notification of the identification of received event data. The method includes the step of receiving, by the notification service, a second identification of received event data. The method includes the step of determining, by the notification service, that the second identification of received event data and the first identification of received event data relate to a single event. The method includes the step of selecting, by the notification service, one of the second identification of received event data and the first identification of received event data, responsive to user-specified notification criteria, after the predetermined period of time elapses. The method includes the step of transmitting, by a communications agent, to a mobile device associated with the user, a notification of the selected identification of received event data. In some embodiments, the method includes the step of determining, by the notification service, that the second identification of received event data identifies an event associated with an identification number with which the event identified in the first identification of received event data is associated.

In still even another aspect, a system for transmitting, to a mobile device, responsive to presence-based filtering, a notification of data received by at least one information repository identified by a user of the mobile device includes at least one notification agent, a presence agent, a notification service, and a communications agent. The at least one notification agent monitors at least one information repository identified by a user and receiving an identification of a modification to the at least one information repository. The presence agent provides presence-related data associated with the user. The notification service, in communication with the at least one notification agent and with the presence agent, applies a filter to the presence-related data and generates a message including the identification of the modification, responsive to the application of the filter to the received presence-related data. The communications agent transmits the generated message to a mobile device associated with the user. In some embodiments, the information repository is a website or web-based information repository. In other embodiments, the information repository does not have a web-based interface or an Internet presence.

In yet another aspect, a method for transmitting, to a mobile device, responsive to presence-based filtering, a notification of data received by at least one information repository identified by a user of the mobile device includes the step of monitoring, by at least one notification agent, at least one information repository identified by a user. The method includes the step of transmitting, by the at least one notification agent, to a notification service, an identification of a modification to the at least one information repository. The method includes the step of requesting, by the notification service, from a presence agent, presence-related data associated with the user and the step of applying, by the notification service, a filter to the received presence-related data. The method includes the step of transmitting, by a communications agent, to a mobile device associated with the user, a notification of the modification, responsive to the application of the filter to the presence-related data.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising local machines in communication with remote machines;

FIGS. 1B and 1C are block diagrams depicting embodiments of computing devices useful in connection with the methods and systems described herein;

FIG. 2A is a block diagram depicting one embodiment of a system for transmitting, to a mobile device, a notification of newly-received personal information manager data associated with a user of the mobile device, responsive to presence-based filtering;

FIG. 2B is a block diagram depicting an embodiment of a system for transmitting, to a mobile device, a notification of newly-received personal information manager data associated with a user of the mobile device, responsive to presence-based filtering;

FIG. 2C is a block diagram depicting an embodiment of a system for transmitting, to a mobile device, a notification of newly-received personal information manager data associated with a user of the mobile device, responsive to presence-based filtering;

FIG. 2D is a block diagram depicting an embodiment of a graphical user interface displayed to a user and receiving user-specified filtering criteria;

FIG. 3 is a flow diagram depicting one embodiment of the steps taken in a method for transmitting, to a mobile device, a notification of newly-received personal information manager data associated with a user of the mobile device, responsive to presence-based filtering;

FIG. 4 is a block diagram depicting one embodiment of a system transmitting, to a mobile device, a consolidated notification of updated personal information manager data associated with a user of the mobile device;

FIG. 5 is a flow diagram depicting one embodiment of the steps taken in a method for transmitting, to a mobile device, a consolidated notification of updated personal information manager data associated with a user of the mobile device;

FIG. 6 is a block diagram depicting one embodiment of a system for transmitting, to a mobile device, responsive to presence-based filtering, a notification of data received by at least one information repository identified by a user of the mobile device; and

FIG. 7 is a flow diagram depicting one embodiment of the steps taken in a method for transmitting, to a mobile device, responsive to presence-based filtering, a notification of data received by at least one information repository identified by a user of the mobile device.

### DETAILED DESCRIPTION OF THE INVENTION

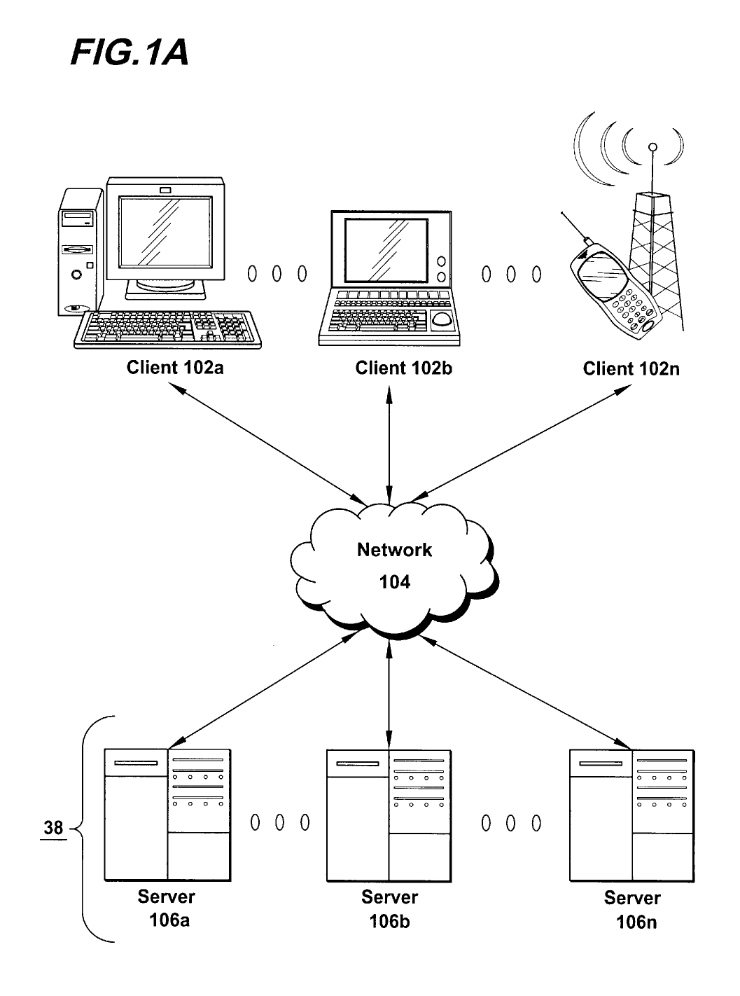

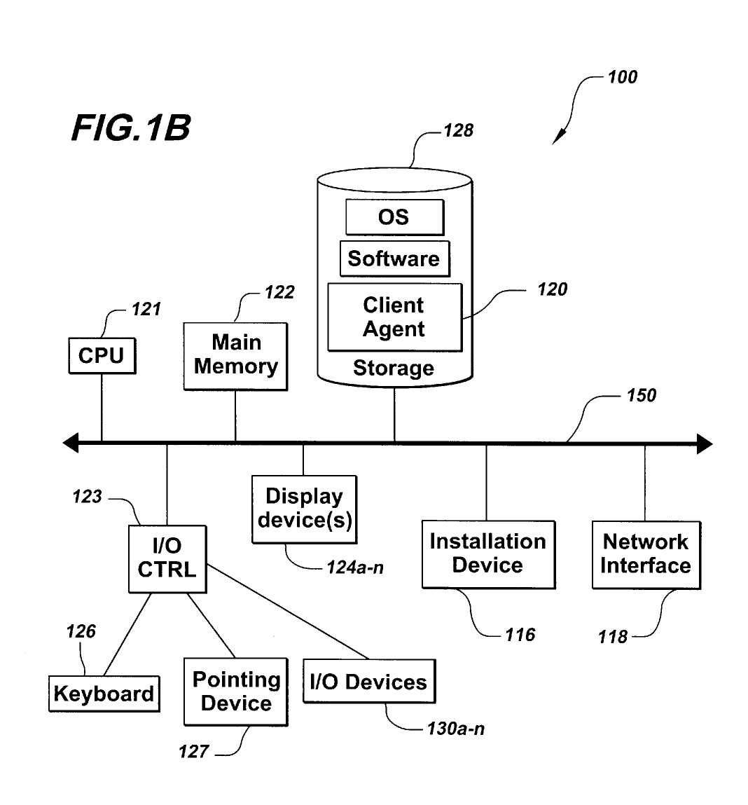

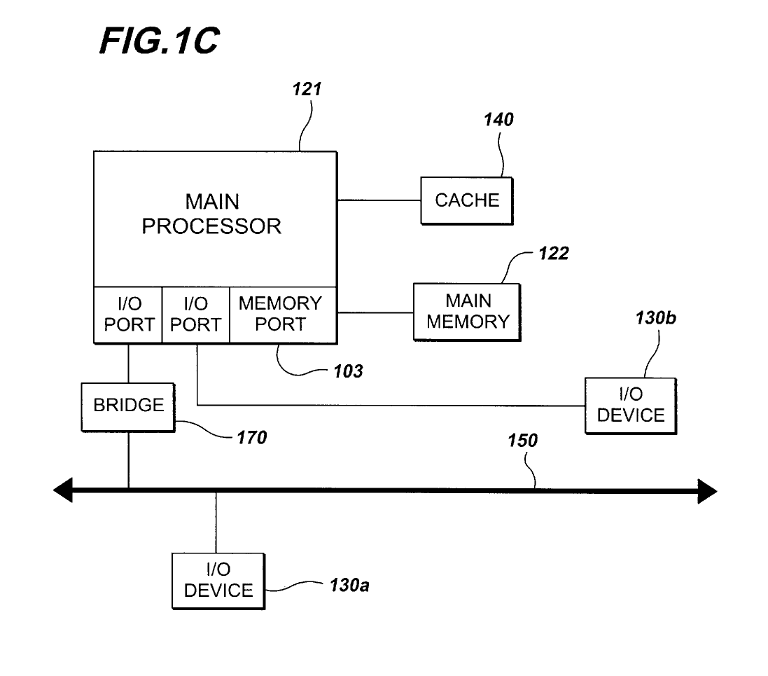

Referring now to FIG. 1A, an embodiment of a network environment is depicted. In brief overview, the network environment comprises one or more clients 102a-102n (also generally referred to as local machine(s) 102, client(s) 102, client node(s) 102, client computer(s) 102, client device(s) 102, or endpoint(s) 102) in communication with one or more servers 106a-106n (also generally referred to as server(s) 106, or remote machine(s) 106) via one or more networks 104.

Although FIG. 1A shows a network 104 between the clients 102 and the servers 106, the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, a network 104 may employ one or more of the following protocols: Enhanced Data rates for GSM Evolution (EDGE), Personal Digital Cellular (PDC), Integrated Digital Enhanced Network (iDEN), High-Speed Uplink Packet Access (HSUPA) UMTS, High Speed Downlink Packet Access (HSDPA) UMTS, Freedom of Mobile Multimedia Access (FOMA), Time Division-Synchronous Code Division Multiple Access (TD-SCDMA), Time Division-Code Division Multiple Access (TD-CDMA), UMTS-Time division duplexing (UMTS-TDD), UMTS Long Term Evolution (LTE), Frequency division multiplexing (FDM), Frequency division duplexing (FDD), Direct Sequence Ultra wide band (DS-UWB), Internet Protocol multimedia Subsystem (IMS), Session Initiation Protocol (SIP), Orthogonal Frequency Division Multiple (OFDM), Orthogonal Frequency Division Multiple Access (OFDMA), Software-defined radio (SDR), Personal Communications Service (PCS), High-Speed Circuit-Switched Data (HSCSD), Ultra Wideband (UWB), Wideband Integrated Dispatch Enhanced Network (WiDEN), Unlicensed Mobile Access (UMA), WiMax IEEE 802.16, WiFi IEEE 802.11, Wireless Local Area Network (WLAN), Circuit Switched Data (CSD), wireless wide-area network (WWAN), Voice over Internet Protocol (VOIP), Wireless Broadband (WiBro), Time Division CDMA (TD-CDMA), Voice over WLAN (VoWLAN), Multiple-input multiple-output (MIMO), Variable-Spreading-factor Spread Orthogonal Frequency Division Multiplexing, Push to Talk (PTT), Signaling System 7 (SS7), SS7 over IP, Message Transfer Part-Level 2 Peer-to-Peer Adaptation Layer (M2PA), Message Transfer Part—Level 3 User Adaptation Layer (M3UA), and Common Channel Signaling System 7 (CCS7).

In some embodiments, the network 104 is a packet switched network. In one of these embodiments, a packet switched network refers to a data communications network where information (e.g., voice and data) is divided into packets and delivered to their destination separately and possibly via different paths. Some packet switched networks provide voice-over-IP (VoIP) functionality. In another of these embodiments, a computer 106 can deliver notifications to client machines 102—including any mobile telephone, pager, fax machine, computer, soft-phone, VoIP handset, wireless VoIP handset, or other device capable of transmitting and receiving data—terminated on the packet switched network 110.

In some embodiments, the network 104 is a circuit switched network. In one of these embodiments, the network 104 routes traffic between an originator and a destination through switching centers, from local users or from other switching centers, whereby a continuous electrical circuit is established and maintained between the calling and called stations until it is released by one of those stations. For example, a circuit switched network can be the public switched telephone network (PSTN). In another of these embodiments, a computer 106 can deliver notifications to client machines 102 that may communicate partially through a packet-switched network and partially through a circuit switched network.

In some embodiments, the network 104 is a mobile phone network. In one of these embodiments, the network 104 includes facilities operated by a telephony carrier for the purposes of providing public mobile telecommunications services. In another of these embodiments, a computer 106 can deliver notifications to client machines 102 terminated on the mobile network.

A network 104 may comprise one or more, and any or all of the following: wireless devices described in the art as Mobile Stations (MS) 101; Base transceiver stations (BTS), Base station controllers (BSC), Mobile switching centers (MSC), Home location registers (HLR), Authentication centers (AuC), Visitor location registers (VLR), Gateway mobile switching centers (GMSC), Public Switched Telecomm Networks (PSTN), Short Message Service centers (SMSC), Equipment Identity Registers (EIR), Unstructured Supplementary Services Data (USSDGW) gateways, Internet Application Servers (IAS), Gateway General Packet Radio Service (GPRS) Support Nodes (GGSN), Serving GPRS Support Nodes (SGSN), Packet Data Networks (PDN), SIM OTA Servers (OTA), and SMS Gateway MSCs (SMS GMSC).

In one embodiment, the system may include multiple, logically-grouped servers 106. In these embodiments, the logical group of servers may be referred to as a server farm 38. In some of these embodiments, the servers 106 may be geographically dispersed. In some cases, a farm 38 may be administered as a single entity. In other embodiments, the server farm 38 comprises a plurality of server farms 38. The servers 106 within each farm 38 can be heterogeneous. One or more of the servers 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux).

The servers 106 of each farm 38 do not need to be physically proximate to another server 106 in the same farm 38. Thus, the group of servers 106 logically grouped as a farm 38 may be interconnected using a wide-area network (WAN) connection or a metropolitan-area network (MAN) connection. For example, a farm 38 may include servers 106 physically located in different continents or different regions of a continent, country, state, city, campus, or room. Data transmission speeds between servers 106 in the farm 38 can be increased if the servers 106 are connected using a local-area network (LAN) connection or some form of direct connection.

A server 106 may be a file server, application server, web server, proxy server, appliance, network appliance, gateway, application gateway, gateway server, virtualization server, deployment server, SSL VPN server, or firewall. In one embodiment, a server 106 provides a remote authentication dial-in user service, and is referred to as a RADIUS server. In another embodiment, a server 106 may include an Active Directory. In some embodiments, the server 106 comprises an appliance such as one of the line of appliances manufactured by the Citrix Application Networking Group, of San Jose, Calif., or Silver Peak Systems, Inc., of Mountain View, Calif., or of Riverbed Technology, Inc., of San Francisco, Calif., or of F5 Networks, Inc., of Seattle, Wash., or of Juniper Networks, Inc., of Sunnyvale, Calif.

In one embodiment, the server 106 may run an application, which, for example, may be an application server providing email services such as MICROSOFT Exchange manufactured by the Microsoft Corporation of Redmond, Wash., a web or Internet server, or a desktop sharing server, or a collaboration server. In another embodiment, the server 106 provides the functionality of a web server. In still another embodiment, a server 106a receives requests from the client 102, forwards the requests to a second server 106b and responds to the request by the client 102 with a response to the request received from the server 106b. In still another embodiment, the server 106a presents the response to the request to the client 102 using a web interface. In one embodiment, the client 102 communicates directly with the server 106b to access the identified application.

The clients 102 may also be referred to as client nodes, client machines, endpoint nodes, or endpoints. In some embodiments, a client 102 communicates with a server 106. In one embodiment, the client 102 communicates directly with one of the servers 106 in a farm 38. In another embodiment, the client 102 communicates with the server 106 in the farm 38 through a network 104.

A client 102 may execute, operate or otherwise provide an application, which can be any type and/or form of software, program, or executable instructions. In one embodiment, the application may be any type and/or form of web browser, web-based client, client-server application, a thin-client computing client, an ActiveX control, or a Java applet, or any other type and/or form of executable instructions capable of executing on client 102. In some embodiments, the application may be a server-based or a remote-based application executed on behalf of the client 102 on a server 106. The application can use any type of protocol and it can be, for example, a POP client, an IMAP client, an HTTP client, an FTP client, an Oscar client, or a Telnet client. In other embodiments, the application comprises any type of software related to voice over internet protocol (VoIP) communications, such as a soft IP telephone. In further embodiments, the application comprises any application related to real-time data communications, such as applications for streaming video and/or audio.

In one embodiment, the client 102 is a wireless device including a Subscriber Identity Module (SIM), a radio transceiver and an external user interface. In another embodiment, the term wireless device refers to any device capable of transmitting and receiving voice and/or data (non-voice) information to and from a network without the use of wires, cables or other tangible transmission media. In still another embodiment, the client 102 is a mobile phone, a cellular phone, a smart phone, a fixed-mobile convergence phone, a satellite phone, a wireless data card, a wireless personal digital assistant (PDA), or other computing device systems communicates wirelessly.

In one embodiment, the client 102 includes an optional SIM. A SIM may be a smart card that may comprise one or more of: CPU, Cryptographic Processor, Read only memory (ROM), Random access memory (RAM), Electrically-Erasable Programmable Read-Only Memory (EEPROM) and input/output circuits. In another embodiment, A SIM may be used to store unique subscription and authentication information about the owner of the SIM, the network that the SIM has permission to connect to, the services that the SIM may access on a network and an address book of telephone numbers. A SIM may comprise one or more applications, including but not limited to banking, biometric, medical, security, productivity, identity management, digital signature, public key infrastructure (PKI), multimedia, ticketing, digital rights management, gaming, and loyalty applications. The SIM applications may employ SIM Application Toolkit (SAT) technology or other smart card application technologies.

In another embodiment, a client 102 includes a Universal Integrated Circuit Card (UICC). A UICC may comprise one or more Identity Module (IM) technologies of: GSM Subscriber Identity Module (SIM), UMTS Internet Protocol Multimedia Services Identity Module (ISIM), CDMA Removable User Identity Module (R-UIM), plus value added applications. The UICC applications may use one or more technologies of: USAT (Universal SIM Application Toolkit), CCAT (CDMA Card Application Toolkit), CAT (Card Application Toolkit), UATK (UIM Application Toolkit) or other smart card technologies. In this context SIM is used generically to represent both the SIM card and the UICC with a USIM, or other IM, application residing on the UICC.

In the embodiment shown, a client 102 may include an external interface (EI). An external interface may comprise one or more of: man-machine interface (MMI) and machine-to-machine interface (M2M). An MMI may comprise any device allowing a person to interact with or operate the wireless device, including without limitation a screen, camera, finger print reader, a keyboard, a keypad, a microphone, optical sensor, audio sensor, a motion sensor, a speaker. An M2M may comprise any device allowing another device to exchange data with the wireless device or operate the wireless device, including without limitation, an RS-232 serial communication data port, manufacturer's proprietary communication data port, Universal Serial Bus (USB) data port, Bluetooth transceiver data port, Ultra Wideband (UWB) transceiver data port, Infrared data port, other short range radio frequency technology data port, or other data port that allows a wireless device to communicate with another device.

The client 102 can also include one or more PIM applications including, but not limited to, a contact list, an address book, a calendar, and an email program. In some embodiments, synchronization between the PIM information of the client 102 and a server 106 can occur. This synchronization may be performed without the need to download or install additional software on the mobile device. In other embodiments, however, the synchronization is performed using a client application.

The client 102 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a visual display device 124, a keyboard 126 and/or a pointing device 127, such as a mouse. As shown in FIG. 1C, each computing device 100 may also include additional optional elements, such as one or more input/output devices 130a-130b (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HyperTransport, Rapid I/O, or InfiniBand. FIG. 1C also depicts an embodiment in which local busses and direct communication are mixed: the processor 121 communicates with I/O device 130a using a local interconnect bus while communicating with I/O device 130b directly.

The computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any client agent 120, or portion thereof. The computing device 100 may further comprise a storage device, such as one or more hard disk drives or redundant arrays of independent disks, for storing an operating system and other related software, and for storing application software programs such as any program related to the client agent 120. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS). In another embodiment, other protocols are used, such as a modified transport control protocol, for example a Transaction TCP (T/TCP), TCP with selection acknowledgements (TCPSACK), TCP with large windows (TCP-LW), a congestion prediction protocol such as the TCP-Vegas protocol, and a TCP spoofing protocol. In other embodiments, any type and form of user datagram protocol (UDP), such as UDP over IP, may be used. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS 2008, WINDOWS NT 3.51, WINDOWS NT 4.0, WINDOWS CE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others. In some embodiments, a computing device 100 operates under the control of an operating system designed for use with mobile devices, such as 2.5G and 3G mobile phones. In one of these embodiments, the operating system is Symbian OS, the open operating system distributed by Symbian Software Limited of London, UK.

The computing device 100 can be any workstation, desktop computer, laptop or notebook computer, server, handheld computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. For example, the computing device 100 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, Calif. In another of these embodiments, the digital audio player may function as both a portable media player and as a mass storage device. In other embodiments, the computing device 100 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a Motorola RAZR or Motorola ROKR line of combination digital audio players and mobile phones. In another of these embodiments, the computing device 100 is an iPhone smartphone, manufactured by Apple Computer of Cupertino, Calif.

In some embodiments, the computing device 100 connects to a second computing device 100′ on a network using any one of a number of well-known protocols from the GSM or CDMA families, such as W-CDMA. These protocols support commercial wireless communication services and W-CDMA, in particular is the underlying protocol supporting i-Mode and mMode services, offered by NTT DoCoMo.

In some embodiments, the computing device 100 communicates with the computing device 100′ when providing a user with a service made available by the Global System for Mobile Communications (GSM) standard. In other embodiments, the computing device 100 provides a user with a short message service (SMS). In one of these embodiments, the computing device 100 may transmit messages to the second computing device 100′ via an intermediate computer 100″, such as a short message service center. In another of these embodiments, the computing device 100 may transmit messages to the second computing device 100′ according to a telecommunications protocol standard for transmitting digital data on a broadband network, such as the Signaling System 7 (SS7) protocol. In still other embodiments, the computing device 100 transmits enhanced short messages to the computing device 100′.

In other embodiments, the computing device 100 transmits text messages to the computing device 100′. In one of these embodiments, the text messages comply with the GSM standard for short messages. In another of these embodiments, the computing device 100, 100′, 100″ transmit text messages that do not comply with a GSM standard. In still another of these embodiments, the computing device 100 transmits text messages over a control channel between the computing device 100 and a cell phone tower, which forwards the text messages to the recipient computer 100′.

In one embodiment, a message transmitted by the computing device 100 has a character length of 160 characters. In another embodiment, a message transmitted by the computer 100 has a character length of 70 characters when non-Latin alphabets, such as Arabic and Chinese, are used. In still another embodiment, a display is provided of the number of total characters in the message. In some embodiments, a message is one of a plurality of messages forming a concatenated SMS messages, which, when combined, have a character length exceeding 160 characters.

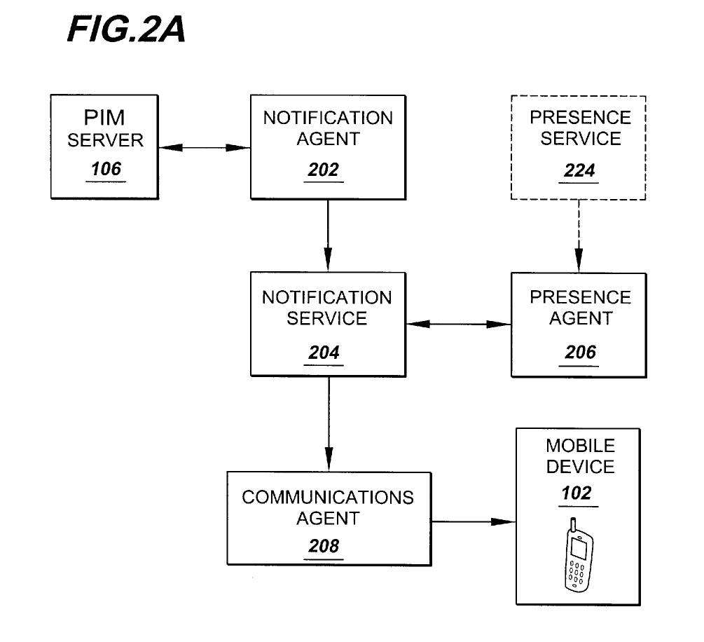

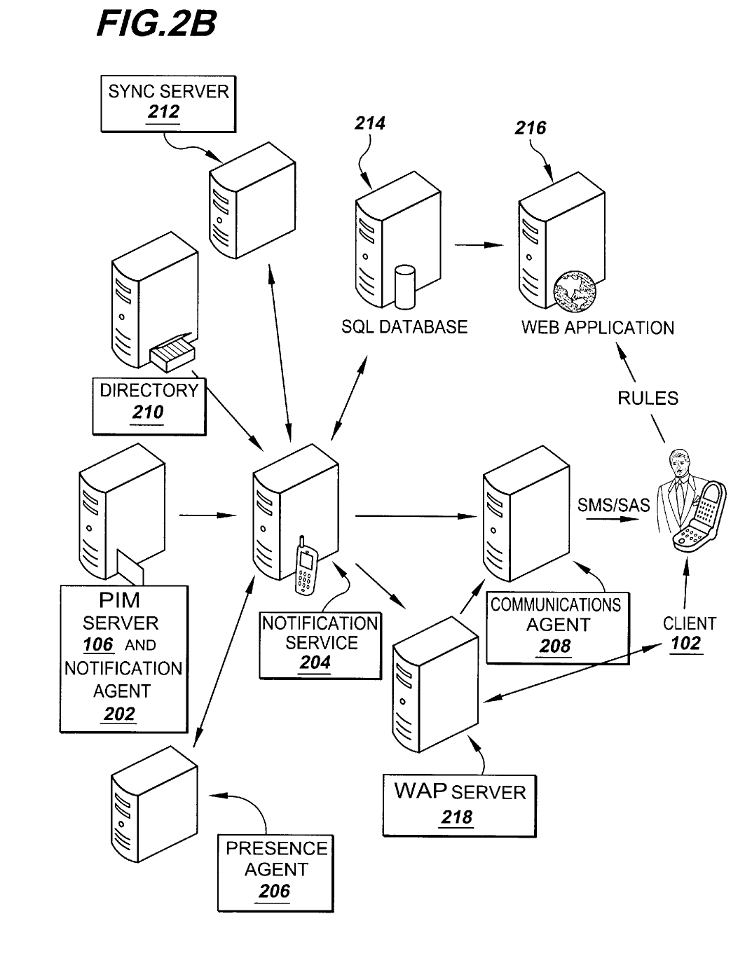

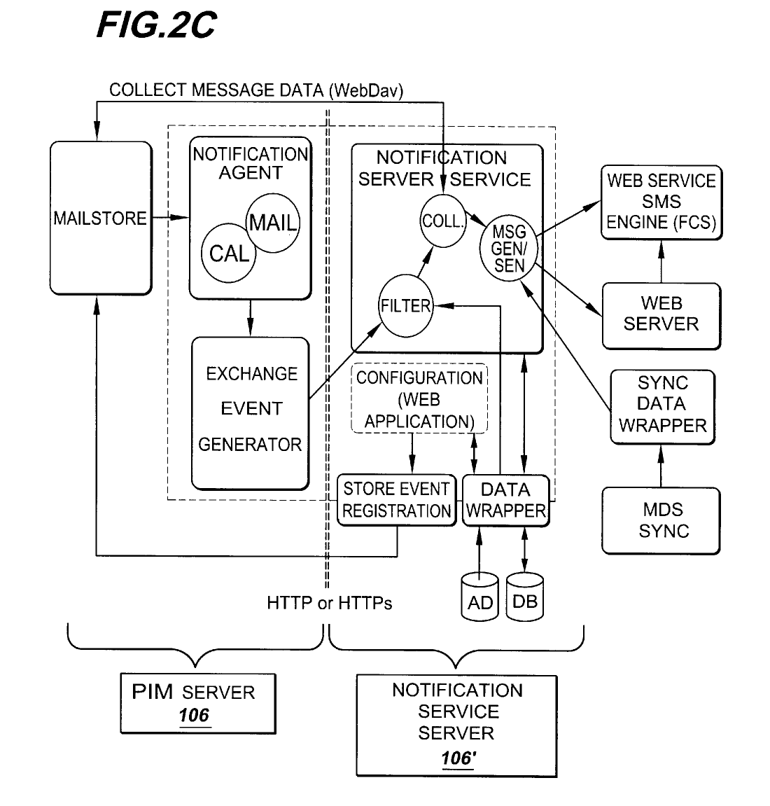

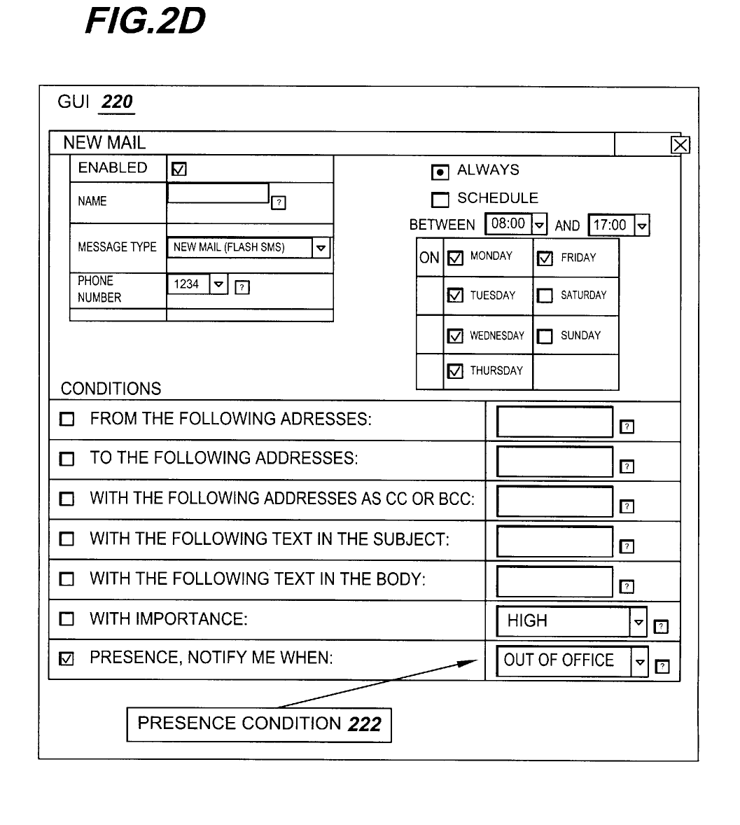

Referring now to FIG. 2A, a block diagram depicts one embodiment of a system for transmitting, to a mobile device, a notification of newly-received personal information manager data associated with a user of the mobile device, responsive to presence-based filtering. In brief overview, the system includes a notification agent 202, a notification service 204, a presence agent 206, a communications agent 208, a mobile device 102 and a server 106. The notification agent 202 receives an identification of data received for a user of a personal information manager. The presence agent 206 provides presence-related data associated with the user. The notification service 204, in communication with the notification agent 202 and with the presence agent 206, applies a filter to presence-related data and generates a message including the identification of the received data, responsive to the application of the filter to the received presence-related data. The communications agent 208 transmits the generated message to a mobile device 102 associated with the user. In one embodiment the personal information manager resides on a server 106. In another embodiment, the mobile device 102 is a client device 102 as described above in connection with FIGS. 1A-1B.

In one embodiment, the notification service 204 sends notification messages to a user's mobile device 102 after a personal information manager receives new or updated electronic mail messages, calendar events, meeting requests, or other personal information manager data (PIM data). In another embodiment, the notification service 204 receives a notification from a notification agent 202 indicating that the personal information manager received the new or updated data and the notification service 204 applies at least one filter to the notification to determine whether or not to send the notification to the user. In some embodiments, a user defines a filter identifying a time period during which to send or not send messages. In other embodiments, a user defines a filter identifying at least one presence-based criterion for use in determining whether or not to notify the user of the receipt of new or updated PIM data. In still other embodiments, the notification service 204 transmits the notification to the mobile device 102 of the user via at least one of short message service, multimedia service, server-alerted synchronization, flash short message service, or other message service.

Referring still to FIG. 2A, and in greater detail, the notification agent 202 receives an identification of data received for a user of a personal information manager. In one embodiment the personal information manager executes on a server 106. In another embodiment, the personal information manager is an application such as MICROSOFT Exchange, manufactured by the Microsoft Corporation of Redmond, Wash.; GOOGLE CALENDAR manufactured by Google, Inc., of Mountain View, Calif.; MICROSOFT OUTLOOK, manufactured by the Microsoft Corporation of Redmond, Wash.; YAHOO! Calendar manufactured by YAHOO! Inc., of Sunnyvale, Calif.; and Palm OS manufactured by Palm, Inc. of Sunnyvale, Calif.

In one embodiment, the personal information manager receives personal information manager data (which may be referred to as PIM data) addressed to a user of the personal information manager. For example, and in another embodiment, the personal information manager may provide an email account for the user and receive a new email message addressed to the user. In still another embodiment, the personal information manager may provide a calendar management or event planning system and receive a new calendar event message addressed to the user. In yet another embodiment, the personal information manager may provide a contacts management system, address book functionality, or customer relationship management system and receive a new contact in a message addressed to the user. In some embodiments, the personal information manager provides, without limitation, some or all of the following functionality: diary or journaling functionality, address books, task lists, significant and recurring events, calendar and event planning functionality (including appointments and meetings as well as social planning), reminders, electronic mail, instant message services, and social networking functionality. In other embodiments, in addition to receiving new data for the user, the personal information manager may receive updates to existing data managed for the user by the personal information manager.

In one embodiment, the notification agent 202 includes a receiver receiving, from the personal information manager, the identification of the received data. In another embodiment, the notification agent 202 includes a query component in communication with a personal information manager. In still another embodiment, the query component interfaces with functionality provided by the personal information manager—for example, with the mailbox functionality—to determine whether the personal information manager has received new or updated PIM data.

In one embodiment, the identification of the received data is a notification that a mail server has received new mail. In another embodiment, the identification of the received new mail includes an identification of a type of mail message received. In still another embodiment, types of mail messages include mail containing voice mail, mail containing attachments, mail containing fax messages, mail including SMS or MMS messages, and mail received from a customer relationship management service. In still even another embodiment, the identification of the received new mail includes an identification of an originator of the new mail. In some embodiments, the notification agent 202 forwards the identification of the type of mail to the notification service 204 for use in applying a filter to the identification of received data.

In one embodiment, the identification of the received data is a notification that a server executing a calendaring application has received a new calendar event. In still another embodiment, the identification of the received data is a notification that a server executing a calendaring application has received an update to an existing calendar event. In still even another embodiment, the identification of the received data is a notification that a server executing a contact management application has received new contact information. In yet another embodiment, the identification of the received data is a notification that a customer relationship manager has received new information, such as new relationship information, a received order, or a returned order.

In one embodiment, the notification agent 202 includes a transmitter forwarding the identification of the received data to a notification service 204. In another embodiment, the transmitter forwards an identification of a type of the received data to a notification service 204. In still another embodiment, the transmitter forwards the identification of the received data to a storage element storing a copy of the identification. In some embodiments, the notification agent 202 includes, or is in communication with, a storage element storing a copy of the identification of received data.

In some embodiments, the system includes an event generator in communication with the notification agent 202. In one of these embodiments, the event generator receives the identification of received data from the notification agent 202. In another of these embodiments, the event generator transmits the identification of received data to the notification service 204. In still another of these embodiments, the event generator transmits a copy of the received data to the notification service 204. In yet another of these embodiments, the event generator transmits a copy of the received data to a storage element for storage.

In another of these embodiments, the event generator transmits a copy of the identification of received data to a storage element for storage. In still another of these embodiments, the event generator transmits a copy of the received data to a synchronization server for later transmission to a mobile device 102 associated with the user. In still even another of these embodiments, the event generator includes a transmitter forwarding the identification of the received data to a notification service 204. In yet another of these embodiments, the transmitter forwards an identification of a type of the received data to the notification service 204.

The presence agent 206 provides presence-related data associated with the user. In some embodiments, the presence agent 206 retrieves data associated with a physical location of a user of the notification service. In one of these embodiments, the notification service 204 requests data from the presence agent 206 and determines whether to notify the user of new or updated PIM data responsive to applying a filter to the retrieved presence-related data. In one embodiment, the presence agent 206 identifies the status of an “out-of-office” indication provided by MICROSOFT Exchange and provides the status to the notification service 204 to determine whether to forward alerts to the mobile device of the user. In another embodiment, the presence agent 206 retrieves data allowing the notification service 204 to make a determination about the user's presence and whether or not to notify the user of new or updated data based on a geographic location (e.g., outside or inside a specific radius of a landmarks, such as an office or the home of the end-user). In still another embodiment, the presence agent 206 retrieves presence-related data using GPS transmissions from the mobile device. In still even another embodiment, the presence agent 206 retrieves presence-related data by retrieving information such as a time at which the user retrieved data from a website or received or sent a text message. In yet another embodiment, the presence agent 206 retrieves data associated with the registration of the mobile device 102 with a specific network. For example, session initiation protocol (SIP) invite messages or other network protocol messages can be used to determine presence of the user on a network and, from that, identify the user's physical location.

In one embodiment, the presence agent 206 includes a global positioning system transceiver identifying a physical location of the user. In one embodiment, the presence agent 206 includes a global positioning system transceiver identifying a physical location of a mobile device 102 associated with the user. In another embodiment, the presence agent 206 includes a localization-based system—such as a GSM triangulation system or a WiFi localization system—identifying a physical location of a mobile device 102 associated with the user.

In one embodiment, the presence agent 206 includes a transceiver for requesting an activity status of a client machine associated with the user. In another embodiment, the presence agent includes a transceiver for requesting a connectivity status of a client machine associated with the user. In still another embodiment, the presence agent 206 includes a transceiver for requesting an activity status of an instant messaging account associated with the user. In yet another embodiment, the presence agent 206 includes a transceiver for requesting a connectivity status of a mobile device associated with the user.

In one embodiment, the presence agent 206 includes an interface to a personal information manager. In another embodiment, the presence agent 206 queries the personal information manager via the interface to identify an itinerary associated with the user upon request. In still another embodiment, the presence agent 206 queries the personal information manager via the interface to determine whether the user is scheduled to be in a meeting at a particular time. For example, and in yet another embodiment, the presence agent 206 may include a transceiver for requesting, from a server executing a personal information manager, an identification of an “out-of-office” status associated with the user. In some embodiments, the presence agent 206 communicates with the personal information manager according to a standard. In other embodiments, the presence agent 206 communicates with the personal information manager via an interface provided by the personal information manager. In one of these embodiments, interfaces and protocols supported by the personal information manager include MAPI, Soap, web services, Collaborative Data Objects, OLEDD, and WebDAV.

In some embodiments, the presence agent 206 requests information, such as event data and availability status of a user, and receives information from a server 106 according to a standard, such as the iCalendar standard described in Request for Comment 2445, published by the Internet Engineering Task Force Network Working Group, (referred to as “RFC 2445”). In one of these embodiments, the presence agent 206 communicates with a server 106, such as a server 106 on which a personal information manager executes, to retrieve the presence-related data. In other embodiments, the presence agent 206 requests and receives information, such as calendaring data, task list items, and scheduling program data, from a server 106 via a transport and platform-independent format, such as the vCalendar format described in RFC 2445, Request for Comment 2446, published by the Internet Engineering Task Force Network Working Group, and Request for Comment 2447, published by the Internet Engineering Task Force Network Working Group. In still other embodiments, the presence agent 206 requests and receives information, such as contact and address book information, from a server 106 according to a standard, such as the vCard standard described in Request for Comment 2425, published by the Internet Engineering Task Force Network Working Group, and Request for Comment 2426, published by the Internet Engineering Task Force Network Working Group.

In one embodiment, the presence agent 206 identifies a time zone of a location in which the user is present at a time when the notification service receives the identification of the received data. In another embodiment, the presence agent 206 identifies a time of day at a location in which the user is present at a time when the notification service receives the identification of the received data. In some embodiments, the presence agent 206 accesses a database storing associations between cities and time zones. In one of these embodiments, the presence agent 206 identifies a time zone of the location in which the user is present by determining from a personal information manager the city the user is in—which may include a default city or a city identified by the user in a calendaring event—and retrieves, from the database the associated time zone.

In some embodiments, the system includes a presence server 224, shown in shadow in FIG. 2A. In one of these embodiments, the presence server 224 monitors one or more data sources for presence-related data associated with the user. In another of these embodiments the presence server 224 communicates with the server 106 to request and receive presence-related data. In still another of these embodiments, the presence server 224 receives an identification of an update to presence-related data. In still even another of these embodiments, the presence server 224 transmits presence-related data to the presence agent 206, which then forwards the presence-related data to the notification service 204. In other embodiments, the presence agent 206 resides on the presence server 224. In still other embodiments, the presence agent 206 provides the functionality of the presence server 224. In yet other embodiments, the presence server 224 provides the functionality of the presence agent 206.

In some embodiments, the notification service 204 is a service executing on a server 105, such as an NT service executing on a MICROSOFT WINDOWS Server 106. In other embodiments, the notification service 204 receives an event identified by the notification agent 202—such as the receipt of new or updated PIM data—and processes the event. In still another embodiment, the notification service 204 instructs a message generator to create a message notifying the user of the event, responsive to the outcome of processing the event.

The notification service 204, in communication with the notification agent 202 and with the presence agent 206, applies a filter to presence-related data associated with the user. In one embodiment, the notification service 204 retrieves a user profile. In another embodiment, the notification service 204 retrieves subscription data associated with the user. In still another embodiment, the notification service 204 applies a filter identified based upon data stored in the user profile. In still even another embodiment, the notification service 204 applies a filter identified based upon data stored in the subscription data. In yet another embodiment, the notification service 204 applies at least one filter to the identification of the notification to determine whether or not to send the notification to the user.

In some embodiments, a filter identifies a time period during which to send or not send messages to a particular user. In other embodiments, a filter identifies a sender or type of sender for whose messages the user wishes to receive or not receive notifications. In still other embodiments, a filter identifies a type of message data—electronic mail or calendar or task list items, for example—for which the user wishes to receive or not receive notifications. In yet other embodiments, a filter identifies at least one presence-based criterion for use in determining whether or not to notify the user of the receipt of new or updated PIM data.

In one embodiment, a filter is a set of rules that are applied to an identification of an event (such as receiving data). In another embodiment, application of a filter results in a determination to send, not send, or delay the sending of a notification of the event to a user associated with the event. In still another embodiment, a filter identifies the resulting action the notification service 204 should take for an event that matches the filter. In still even another embodiment, a rule is a single filtering statement. In another embodiment, a rule includes a plurality of filtering statements that may be combined into a single filter—for example, via Boolean logic. In yet another embodiment, a filter set is an ordered list of filters associated with a user that results in an action upon application of the filter set to an event associated with the user.

The notification service 204 generates a message including the identification of the received data, responsive to the application of the filter to the received presence-related data. In one embodiment, the notification service 204 includes a message generating component generating the message. In another embodiment, the message generating component generates a short message service-compliant message. In still another embodiment, the message generating component generates a multimedia message service-compliant message. In some embodiments, the message generating component generates an SMS-compliant message including a hyperlink. In one of these embodiments, the message generating component generates the SMS-compliant message including a hyperlink responsive to receiving an indication that the mobile device 102 supports the use of hyperlinks. In another of these embodiments, the hyperlink within the SMS-compliant message allows the user to view the new or updated data received by the personal information manager.

The communications agent 208 transmits the generated message to a mobile device 102 associated with the user. In one embodiment, the mobile device 102 is a mobile device. In one embodiment, the communications agent 208 includes a transmitter sending short message service-compliant messages to the mobile device 102. In another embodiment, the transmitter sends multimedia message service-compliant messages to the mobile device 102. In still another embodiment, the communications agent 208 receives, from a wireless application protocol (WAP) server, an instruction to transmit a short message service-compliant message including a server-alerted synchronization notification to the mobile device 102. In some embodiments, the communications agent 208 executes on a communications server. In other embodiments, the communications agent 208 provides a transport service for delivering messages to users.

Referring now to FIG. 2B, a block diagram depicts an embodiment of the system for transmitting, to a mobile device, a notification of newly-received personal information manager data associated with a user of the mobile device, responsive to presence-based filtering. The system includes a mobile device 102, a server 106, a notification agent 202, a notification service 204, a presence agent 206, a communications agent 208, a directory 210, a sync server 212, a database 214, a web server 216, and a wireless application protocol (WAP) server 218.

In one embodiment, the directory 210 is a database that holds information about component locations, users, groups, passwords, security, and other COM information. In some embodiments, the database supports access via the Lightweight Directory Access Protocol. In another embodiment, the directory 210 is an ACTIVE DIRECTORY provided by MICROSOFT Corporation of Redmond, Wash. In still another embodiment, other services provide the functionality of the directory 210. In yet another embodiment, the directory 210 stores at least one filter for use in determining whether to notify a user of a personal information manager of the receipt of new or updated PIM data.

In one embodiment, the database 214 is an SQL database. In another embodiment, the database 214 stores information about mobile devices 102 and an association between a mobile device 102 and a user of the personal information manager. In still another embodiment, the information about a mobile device 102 includes data regarding formatting requirements of the mobile device 102; for example, the information may include information about a display of the mobile device 102 or about a format supported by a mobile device application, such as a client-side PIM application. In yet another embodiment, the database 214 stores an association between the user of the mobile device 102 and at least one presence-based filter. In some embodiments, the notification service 204 retrieves information from the database 214 to apply a filter to the identification of the notification of received data or to the presence-based data associated with the user.

In some embodiments, the directory 210 provides the notification service 204 with access to user and organization profiles. In another embodiment, the database 214 provides the notification service 204 with access to data associated with user preferences, such as default time zones, cultural information, passwords, and other user data. In some embodiments, user and organization data is inherited from the directory 310. In other embodiments, user and organization data is stored in and retrieved from the database 214.

In some embodiments, the databases and data stores described herein store data in an ODBC-compliant database. For example, the databases and data stores may be provided as ORACLE databases, manufactured by Oracle Corporation of Redwood Shores, Calif. In other embodiments, the databases and data stores can be MICROSOFT ACCESS databases or MICROSOFT SQL server databases, manufactured by MICROSOFT Corporation of Redmond, Wash. In still other embodiments, the databases may be custom-designed databases based on an open source database such as the MYSQL family of freely-available database products distributed by MySQL AB Corporation of Uppsala, Sweden, and Cupertino, Calif.

In some embodiments, the system includes a graphical user interface displayed to a user and allowing the user to configure one or more filters associated with the user. In one of these embodiments, a web server 216 displays the graphical user interface to a user via across a network 104. In one of these embodiments, a user accesses the graphical user interface to subscribe to a notification service and request filtered notifications of new or updated PIM data. In another of these embodiments, the user accesses the graphical user interface to provide the system with information associated with the user's mobile device 102, such as the user's mobile device number or device type. In still another of these embodiments, a user is an administrator and accesses the graphical user interface to subscribe a plurality of other users to the notification service and request policy-based filtering of notifications.

Referring now to FIG. 2D, a block diagram depicts one embodiment of a graphical user interface displayed to a user and receiving user-specified filtering criteria. The graphical user interface 220 displays a plurality of interface element with which a user interacts to define a filter or rule regarding when to notify the user of new or updated data. In one embodiment, the graphical user interface 220 includes an interface element 222 specifying a presence condition. In another embodiment, presence conditions include, without limitation, whether the user is presently in his or her office, away from his or her office either temporarily (for a meeting) or for an extended period of time (for a business trip), connected to a machine connected to his or her corporate network (logged on to his or her work machine, for example), actively using a machine connected to his or her corporate network (that is, logged in and active, as opposed to logged in but not using his or her machine), actively connected to an instant messaging service, and actively connected to a mobile network.

Referring back to FIG. 2C, and in one embodiment, the notification service 204 transmits, to a wireless application protocol (WAP) server 218, via a push access protocol (PAP), an instruction to transmit a server-alerted synchronization notification. In another embodiment, the WAP server 218 transmits to the communications agent 208 an instruction to transmit a short message service to the mobile device 102 of the user. In still another embodiment, the communications agent 208 transmits a server-alerted synchronization notification to the mobile device 102. In some embodiments, upon receiving the notification, a user of the mobile device 102 may initiate synchronization of data on the mobile device 102 with data stored by the personal information manager. In some embodiments, upon receiving the notification, a user of the mobile device 102 may initiate synchronization of data on the mobile device 102 with data stored by the notification service. In one of these embodiments, the mobile device 102 synchronizes with a sync server 212, which stores a copy of the new or updated data, or which is in communication with a storage element storing the new or updated data. In other embodiments, the mobile device 102 maintains an open connection with the WAP server 218. In one of these embodiments, the WAP server 218 may transmit the server-alerted synchronization notification directly to the mobile device 102. In still other embodiments, the WAP server 218 communicates with the mobile device 102 via WAP Push.

Referring still to FIG. 2C, a block diagram depicts another embodiment of a system for transmitting, to a mobile device, a notification of newly-received personal information manager data associated with a user of the mobile device, responsive to presence-based filtering. In this embodiment, the notification agent 202 and the personal information manager reside on a server 106. The notification service 204, presence agent 206, web server 216, directory 210 and database 214 reside on a second server 106′. The notification service 204 includes a message generating component. The communications agent 208, WAP server 218, and sync server 212 are provided as separate servers. Therefore, although depicted in FIGS. 2A and 2B as residing on separate servers, it should be understood that each service, directory, database or agent may be provided as part of one or more physical servers. Furthermore, and as shown by way of example in FIG. 2C, it should be understood that the system may provide multiple ones of any or each of those components, although only one of each is depicted in FIG. 2-C.

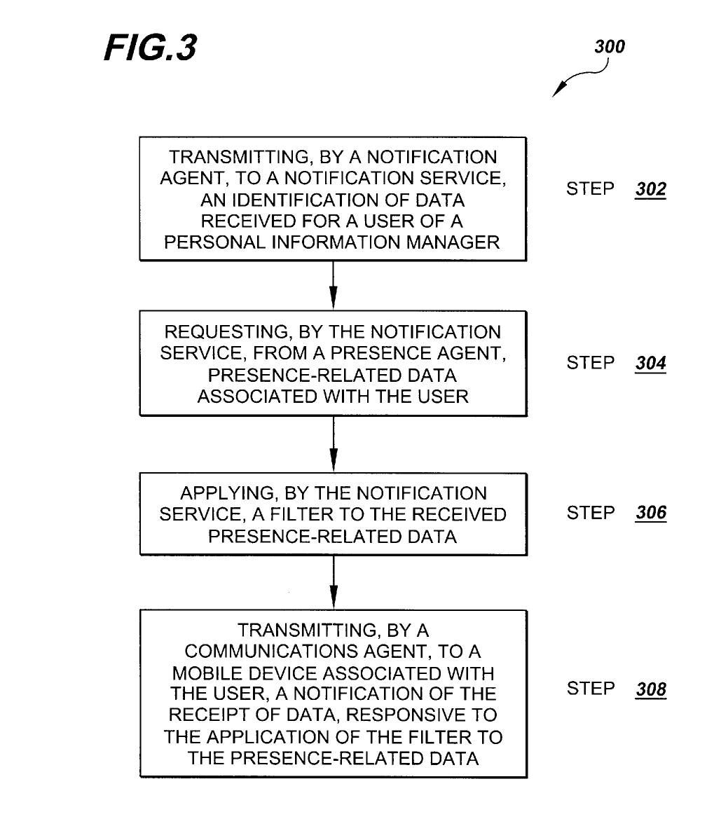

Referring now to FIG. 3, a flow diagram depicts one embodiment of the steps taken in a method for transmitting, to a mobile device, a notification of newly-received personal information manager data associated with a user of the mobile device, responsive to presence-based filtering. In brief overview, the method 300 includes the step of transmitting, by a notification agent, to a notification service, an identification of data received for a user of a personal information manager (step 302). The method includes the step of requesting, by the notification service, from a presence agent, presence-related data associated with the user (step 304). The method includes the step of applying, by the notification service, a filter to the received presence-related data (step 306). The method includes the step of transmitting, by a communications agent, to a mobile device associated with the user, a notification of the receipt of data, responsive to the application of the filter to the presence-related data (step 308).

Referring now to FIG. 3, and in greater detail, the notification agent transmits, to a notification service, an identification of data received for a user of a personal information manager (step 302). In one embodiment, the notification agent 202 receives the identification of received data from the personal information manager. In another embodiment, the notification agent 202 receives the identification of received data from an event generator. In still another embodiment, the notification agent 202 requests the identification of received data. In still even another embodiment, the notification agent 202 subscribes to receive identifications of updates regarding received data. In still another embodiment, the notification agent 202 transmits, to the notification service 204, an identification of a type of data received for the user. In some embodiments, the notification agent 202 stores a copy of the received data. In one of these embodiments, the notification agent 202 stores a copy of the received data until the notification is transmitted to the user.

The notification service requests, from a presence agent, presence-related data associated with the user (step 304). In one embodiment, the notification service 204 identifies a presence-based filter for use in determining whether to notify the user of the identification of received data. In another embodiment, the notification service 204 identifies presence-based data associated with the user and required for application of the filter. For example, in some embodiments, the notification service 204 may determine that the filter requires sending the user the notification via short message service if the user has an out-of-office status indicating that the user is out of the office. In this example, the notification service 204 requests, from the presence agent 206, an identification of the user's out-of-office status. In another embodiment, the notification service 204 may determine that the filter requires sending the user the notification if the user has an activity status indicating that the user is out of the office or away from the computer, in spite of having turned on the computer or logged into an account. In this embodiment, the notification service 204 may request an identification of whether the user has turned on their computer and whether they have an activity status that indicates they are using their computer.

In some embodiments, the notification agent 202 transmits the identification of the received data to an event generator. In one of these embodiments, the event generator processes the identification. In another of these embodiments, the event generator forwards the identification and information associated with the received data to the notification service 204.

In some embodiments, the notification service 204 receives information associated with the user. In one of these embodiments, the notification service 204 receives an identification of a service plan to which the user subscribes. In another of these embodiments, the notification service 204 retrieves the information from at least one of a directory 210 and a database 214. In still another of these embodiments, the notification service 204 receives an identification of a rule or filter to which the user has subscribed. In yet another of these embodiments, the notification service 204 receives a message formatting definition; for example, the notification service 204 may receive a definition of how an identification of received data is to be converted into a notification for a particular user associated with a particular mobile device 102. The definition may specify a message layout, what information from the identification—if any—is to be included in the notification, and a type of message to generate (SMS, Flash SMS, Server-alerted sync, modified SMS, MMS, GSM Broadcast etc.).

The notification service requests, from a presence agent, presence-related data associated with the user (step 304). In one embodiment, the notification service 204 identifies a presence-based filter for use in determining whether to notify the user of the identification of received data. In another embodiment, the notification service 204 identifies presence-based data associated with the user and required for application of the filter. For example, in some embodiments, the notification service 204 may determine that the filter requires sending the user the notification via short message service if the user has an out-of-office status indicating that the user is out of the office. In this example, the notification service 204 requests, from the presence agent 206, an identification of the user's out-of-office status. In another embodiment, the notification service 204 may determine that the filter requires sending the user the notification if the user has an activity status indicating that the user is out of the office or away from the computer, in spite of having turned on the computer or logged into an account. In this embodiment, the notification service 204 may request an identification of whether the user has turned on their computer and whether they have an activity status that indicates they are using their computer.

In one embodiment, the notification service 204 requests, from the presence agent 206, an indication of a location in which the user is physically present. In another embodiment, the notification service 204 requests, from the presence agent 206, an identification of a time zone of a location in which the user is present at a time when the notification service 204 receives the identification of the received data. In still another embodiment, the notification service 204 requests, from the presence agent 206, an identification of an itinerary associated with the user at a time when the notification service 204 receives the identification of the received data. In still even another embodiment, the notification service 204 requests, from the presence agent 206, an identification of a time of day at a location in which the user is present at a time when the notification service 204 receives the identification of the received data. In yet another embodiment, the notification service 204 requests, from the presence agent 206, an indication of whether a mobile device 102 associated with the user is connected to a network.

In one embodiment, the notification service 204 requests, from the presence agent 206, an indication of whether the user is connected to a client machine associated with the user. In another embodiment, the notification service 204 requests, from the presence agent 206, an indication of a level of activity on a client machine associated with the user; for example, the notification service 204 may request an identification of whether the user has logged on to a machine but is not actively using that machine—whether they are not at their desk. In still another embodiment, the notification service 204 requests, from the presence agent 206, an indication of a level of activity on a server machine associated with the user. In some embodiments, the notification service 204 requests an indication as to whether the user has logged off of a computer 102 or 106 associated with the user.

In one embodiment, the notification service 204 requests, from the presence agent 206, an indication of whether the user is connected to an instant messaging service. In another embodiment, the notification service 204 requests, from the presence agent 206, an indication of a level of activity of the user on an instant messaging service. In still another embodiment, the notification service 204 requests, from the presence agent 206, an identification of an itinerary associated with the user at a time when the notification service 204 receives the identification of the received data. In some embodiments, the notification service 204 requests, from the presence agent 206, an indication of whether a mobile device associated with the user is connected to a network.

In one embodiment, the presence agent 206 queries a PIM interface to determine whether the user is scheduled to be in a meeting. In another embodiment, the presence agent 206 queries a PIM interface to determine whether the user is scheduled to be out of the office. In still another embodiment, the presence agent 206 queries a machine 102 or 106 to determine the last operation time of a logged-on account, in order to determine a level of activity of a user of the machine 102 or 106. In still another embodiment, the presence agent 206 queries a Logon table to determine whether the user has logged on to an account associated with the user. In one embodiment, the presence agent 206 returns the requested presence-related data to the notification service 204.

In one embodiment, the presence agent 206 determines a physical location of a user by identifying a location of a mobile device 102 associated with the user. In another embodiment, the presence agent 206 interfaces with a localization-based system to determine the location of the mobile device 102. In some embodiments, the presence agent 206 subscribes to information distributed by network operators and providing location information associated with a network subscriber's device. In other embodiments, the presence agent 206 subscribes to a service allowing the presence agent 206 to receive location-data based on GPS data. In one of these embodiments, the presence agent 206 receives location coordinates for a mobile device associated with the user. In still other embodiments, the presence agent 206 receives an identification of a location of a user from a personal information manager. In one of these embodiments, the user provides location information when generating or updating a calendaring event (for example, by entering a city name in the location field of the event description). In yet other embodiments, the presence agent 206 receives status information associated with the mobile device via the Signaling System #7 (SS7) set of telephony signaling protocols. In one of these embodiments, the presence agent 206 receives an indication as to whether the mobile device is available on a particular network. In further embodiments, the presence agent 206 tracks the movement of a user by continually monitoring a location of the mobile device. In one of these embodiments, the presence agent 206 transmits the information regarding the movement of a user to the notification service for use in determining whether to notify the user of newly received data.

The notification service applies a filter to the received presence-related data (step 306). In one embodiment, the notification service 204 determines not to notify the user of the receipt of the identified data, responsive to the application of the filter to the presence-related data. For example, the notification service 204 may receive presence-related data indicating that the user is actively using a desktop machine having access to the personal information manager, and the notification service 204 may have retrieved a filter specified by the user indicating that when the user is actively using the desktop machine, the user does not wish to receive a text-message reminder of calendaring event. Alternatively, and in another example, the notification service 204 may receive presence-related data indicating that the user has not logged into a desktop machine having access to the personal information manager and that a mobile device 102 associated with the user has connectivity to a network, and the notification service 204 may have retrieved a filter specified by the user indicating that when the user is away from the office and has access to a network via the mobile device 102, the user should receive a text message reminding them of calendar events and notifying them of newly-received data. In another embodiment, the notification service 204 determines to delay the transmission of a notification, responsive to the application of the filter to the presence-related data. In still another embodiment, the notification service 204 determines to transmit a reformatted version of the notification to the mobile device, responsive to the application of the filter to the presence-related data.

In one embodiment, the notification service 204 generates a notification message for transmission to a mobile device 102 associated with the user. In another embodiment, the notification service 204 forwards the identification of the received data to a message generator. In still another embodiment, the notification service 204 forwards an identification of a type of message to generate. In yet another embodiment, the notification service 204 forwards an identification of a transport protocol for use in transmitting the message. In some embodiments, the message generator generates an SMS-compliant message. In one of these embodiments, the message generates a flash SMS message. In other embodiments, the message generator generates an MMS-compliant message. In still other embodiments, the message generator generates a server-alerted synchronization message.

A communications agent transmits, to a mobile device associated with the user, a notification of the receipt of data, responsive to the application of the filter to the presence-related data (step 308). In some embodiments, the communications agent 208 receives a notification for transmission. In one of these embodiments, the communications agent 208 receives the notification from the notification service 204. In another of these embodiments, the communications agent 208 receives the notification from a message generator. In other embodiments, the communications agent 208 receives an identification of a protocol according to which the communications agent 208 transmits the message. In some embodiments, the communications agent receives, from a WAP server 218, an SMS-compliant text message to transmit to the user. In other embodiments, the communications agent transmits a message across a network 104 as described in connection with FIGS. 1A-1B.

In one embodiment, the communications agent 208 transmits, via short message service, the notification of the receipt of data, responsive to the application of the filter to the presence-related data. In another embodiment, the communications agent 208 transmits, via multimedia message service, the notification of the receipt of data, responsive to the application of the filter to the presence-related data. In still another embodiment, the communication agent transmits, via flash short message service, the notification of the receipt of data. In yet another embodiment, the communications agent 208 transmits, the notification of the receipt of data, responsive to the application of the filter to the presence-related data, the notification formatted to comply with a display requirement of the mobile device 102.

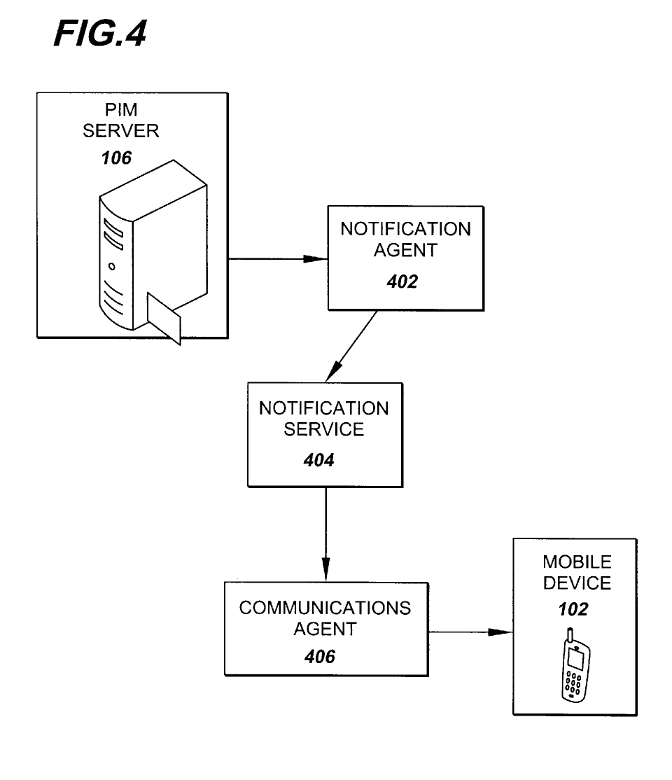

Referring now to FIG. 4, a block diagram depicts a system for transmitting, to a mobile device, a consolidated notification of updated personal information manager data associated with a user of the mobile device. In brief overview, the system includes a mobile device 102, a server 106, notification agent 402, a notification service 404, and a communications agent 406. The notification agent 402 receives a first identification of received event data associated with a user of a personal information manager. The notification service 404 includes: i) means for receiving the first identification of received event data, ii) means for delaying transmission to the user of the first notification of the identification of received event data, iii) means for receiving a second identification of received event data, iv) means for determining, that the second identification of received event data and the first identification of received event data relate to a single event, v) means for selecting one of the second identification of received event data and the first identification of received event data after the predetermined period of time elapses. The communications agent 208 transmits, to a mobile device associated with the user, a notification of the selected identification of received event data.

The notification agent 402 receives a first identification of received event data associated with a user of a personal information manager. In one embodiment, the notification agent 402 is a notification agent 202 as described above in connection with FIGS. 2A-2C. In another embodiment, the event data relates to a calendar event.

In one embodiment, the event data includes data associated with a meeting invitation received by the user. In another embodiment, the event data includes data associated with a meeting invitation accepted by the user. In still another embodiment, the event data includes data associated with an update to a meeting invitation received by the user. In some embodiments, the notification agent 402 receives a plurality of messages relating to a single event.

The notification service 404 includes a receiver for receiving the first identification of received event data and for receiving a second identification of received event data. In one embodiment, the notification service 404 is in communication with the notification agent 402. In another embodiment, the notification service 404 is in communication with an event generator. In still another embodiment, the notification service 404 is a notification service 204 as described above in connection with FIGS. 2A-2C.

The notification service 404 includes means for delaying transmission to the user of the first notification of the identification of received event data. In one embodiment, the notification service 404 includes a buffer storing the first notification of the identification of received data for a preconfigured period of time.

The notification service 404 includes means for determining, that the second identification of received event data and the first identification of received event data relate to a single event. In one embodiment, the notification service 404 identifies a correlation identifier associated with the event and included within both the first identification of received event data and the second identification of received event data.

The notification service 404 includes means for selecting one of the second identification of received event data and the first identification of received event data after the predetermined period of time elapses. In one embodiment, the notification service 404 includes an event correlation table and an event decision table. In another embodiment, the notification service 404 accesses an event correlation table to identify a score assigned to a type of event data for use in ranking a plurality of identifications of received event data. In still another embodiment, the notification service 404 accesses an event decision table to identify an action to take responsive to a score assigned to one or more identifications of received event data.

The communications agent 208 transmits, to a mobile device associated with the user, a notification of the selected identification of received event data. In one embodiment, the communications agent 208 is a communications agent as described above in connection with FIG. 2A-C.

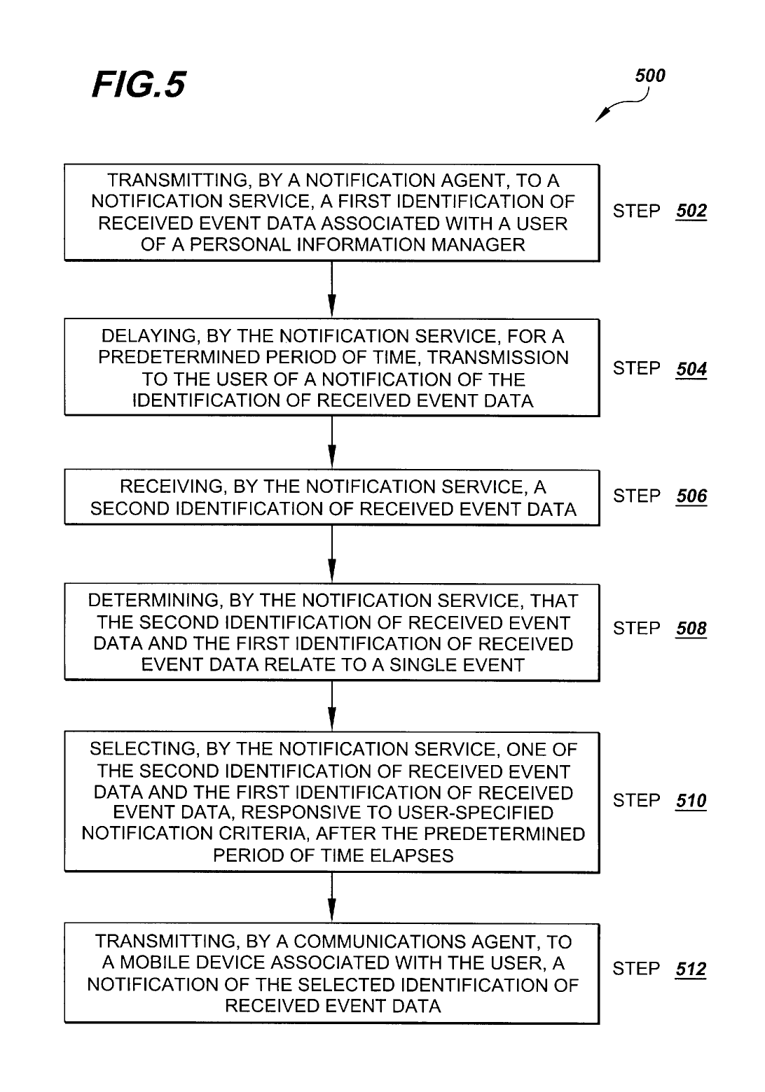

Referring now to FIG. 5, a flow diagram depicts one embodiment of the steps taken in a method for transmitting, to a mobile device, a consolidated notification of updated personal information manager data associated with a user of the mobile device. In brief overview, the method 500 includes the step of transmitting, by a notification agent, to a notification service, a first identification of received event data associated with a user of a personal information manager (step 502). The method includes the step of delaying, by the notification service, for a predetermined period of time, transmission to the user of a notification of the identification of received event data (step 504). The method includes the step of receiving, by the notification service, a second identification of received event data (step 506). The method includes the step of determining, by the notification service, that the second identification of received event data and the first identification of received event data relate to a single event (step 508). The method includes the step of selecting, by the notification service, one of the second identification of received event data and the first identification of received event data, responsive to user-specified notification criteria, after the predetermined period of time elapses (step 510). The method includes the step of transmitting, by a communications agent, to a mobile device associated with the user, a notification of the selected identification of received event data (step 512).

Referring now to FIG. 5, and in greater detail, a notification agent transmits, to a notification service, a first identification of received event data associated with a user of a personal information manager (step 502). In one embodiment, the notification agent 402 receives the first identification of received event data from a server 106 executing a personal information manager.

In some embodiments, the notification service 404 receives the identification of the received event data from an event generator. In one of these embodiments, the event generator receives the identification of the received event data from the notification agent 402. In another of these embodiments, the event generator processes the identification of the received event data prior to sending the identification of the received event data to the notification service 404. In still another of these embodiments, the event generator assigns a correlation identifier to the event data. In yet another of these embodiments, the correlation identifier is generated from an event type, a user identifier, and a unique identifier associated with a calendar event.

The notification service delays, for a predetermined period of time, transmission to the user of a notification of the identification of received event data (step 504). In some embodiments, an administrator specified the predetermined period of time. In other embodiments, the predetermined period of time is configurable. In still other embodiments, the predetermined period of time varies depending on a type of the event data.

The notification service receives, a second identification of received event data (step 506). In one embodiment, the notification service 404 receives the identification of the received event data from an event generator. In another embodiment, the notification service 404 receives a modified identification of the received event data, the modified identification including a correlation identifier.

The notification service determines that the second identification of received event data and the first identification of received event data relate to a single event (step 508). In some embodiments, the notification service 404 receives a processed identification of the received event data. In one of these embodiments, the processed identification includes a correlation identifier, such as a unique identification number assigned to an event and associated with data related to the event. For example, a meeting invitation for an event, one or more attendee acceptances of the meeting invitation for the event, any cancellations, new time proposals, may all share the same correlation identifier, and the correlation identifier may be unique to that event and its data. In another of these embodiments, the notification service 404 uses the correlation identifier to identify data related to the same event. In still another of these embodiments, the notification service 404 uses the correlation identifier to correlate identifications related to the same event data received within a certain time frame.

The notification service selects, one of the second identification of received event data and the first identification of received event data, responsive to user-specified notification criteria, after the predetermined period of time elapses (step 510). In one embodiment, the notification service 404 uses a reference count mechanism to select one of a plurality of identifications of event data related to the same event. In another embodiment, an event correlation table associates a type of event data with an initial value and with a delta value. For example, saving a new event may have an initial value of 0 and a delta value of 1, while saving a change to an existing event may have an initial value of one and a delta value of 0 and while deleting an event may have an initial value of 1 and a delta value of −1. In still another embodiment, the identification of the received event data from an event generator includes an identification of a type of event data receives. In still even another embodiment, the notification service 404 accesses the event correlation table to identify a score associated with a type of received event data identified in each received identification of received event data. For example, and in one embodiment, when a first identification of received event data is received and delayed for a preconfigured time period, the notification service 404 accesses the event correlation to set an initial score for the event based on an event type provided by the first identification. In this embodiment, when the notification service 404 receives a second identification of received event data, the notification service 404 identifies the delta value associated with the type of event in the event correlation table and modifies the initial value by the delta value. In other embodiments, when the notification service 404 identifies the delta value associated with the type of event in the event correlation table, the notification service 404 maintains a list of initial and accumulated values. In one of these embodiments, for example, the notification service 404 stores a table listing an initial value for a first event and listing each default value for each subsequently received event.

In still other embodiments, the notification service 404 receives an initial identification of received event data associated with an event and delays processing for a period of time. In one of these embodiments, the notification service 404 does not receive any additional identifications of received event data during the period of time. In another of these embodiments, the notification service 404 receives at least one additional identification of received event data. In still another of these embodiments, the notification service 404 identifies the at least one additional identification of received event data as associated with the event with which the initial identification of received data is associated. In still even another of these embodiments, upon expiration of the preconfigured period of time, the notification service 404 selects one of the identifications of received event data and notifies a user of the receipt of the event data.

In yet other embodiments, the notification service 404 receives an initial identification of received event data associated with an event. In one of these embodiments, the notification service 404 receives at least one additional identification of received event data. In another of these embodiments, the notification service 404 identifies the at least one additional identification of received event data as associated with the event with which the initial identification of received data is associated. In still another of these embodiments, the notification service 404 delays processing of both the initial identification of received event data and of the subsequently received at least one additional identification of received event data. In still even another of these embodiments, upon expiration of the preconfigured period of time, the notification service 404 selects one of the identifications of received event data and notifies a user of the receipt of the event data.

In some embodiments, the notification service 404 accesses a decision table to identify an action to take. In one of these embodiments, the decision table includes an association between a score and an action. In another of these embodiments, the decision table identifies an action—such as sending a notification of received event data to a user—to take based upon a particular score. In still another of these embodiments, the decision table identifies an action—such as sending a notification of received event data to a user—to take based upon a pattern of scores. For example, the decision table may indicate that if the initial score was 1 and the delta scores include a −1 followed by a 1, then the notification service 404 should provide a notification to the user of the identification of the received event data associated with the delta value of 1.

In some embodiments, the notification service 404 applies a filter to the identified action to determine whether and how to notify the user of the selected identification of received event data. In one of these embodiments, the notification service 404 applies user-specified criteria to identify a type of message to send. In another of these embodiments, the notification service 404 applies a filter to presence-related data associated with the user to determine whether and how to notify the user of the selected identification of received event data.

A communications agent transmits, to a mobile device associated with the user, a notification of the selected identification of received event data (step 512). In one embodiment, the communications agent 208 transmits, via short message service, the notification of the selected identification of received event data. In another embodiment, the communications agent 208 transmits a flash short message service text message. In still another embodiment, the communications agent 208 transmits a server-alerted synchronization message. In still even another embodiment, the communications agent 208 transmits, via multimedia message service, the notification of the selected identification of received event data. In yet another embodiment, the communications agent 208 formats the notification of the selected identification of received event data to comply with a display requirement of the mobile device.

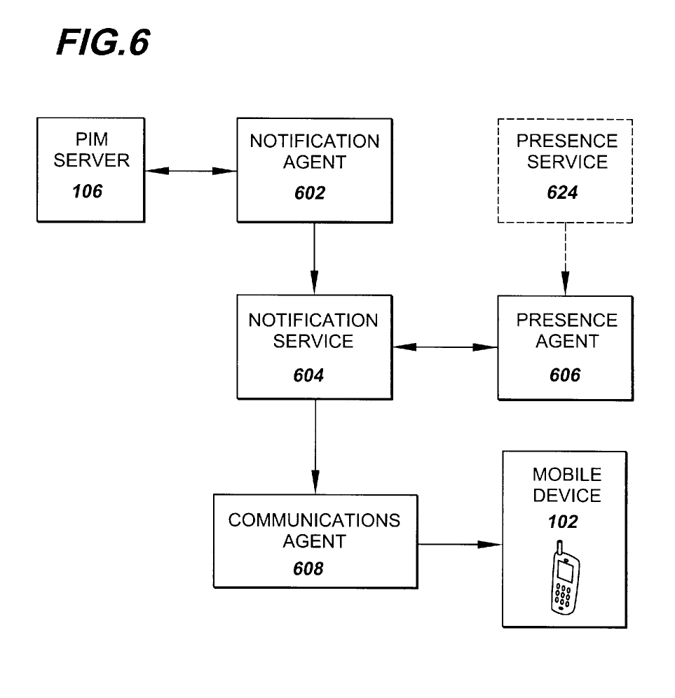

Referring now to FIG. 6, a block diagram depicts one embodiment of a system for transmitting, to a mobile device, responsive to presence-based filtering, a notification of data received by at least one information repository identified by a user of the mobile device. In brief overview, the system includes at least one notification agent 602, a notification service 604, a presence agent 606, and a communications agent 608. In some embodiments, the system includes a presence service 624, shown in shadow in FIG. 6. The at least one notification agent 602 monitors at least one information repository identified by a user and receiving an identification of a modification to the at least one information repository. The presence agent 606 provides presence-related data associated with the user. The notification service 604, in communication with the at least one notification agent and with the presence agent, applies a filter to the presence-related data and generates a message including the identification of the modification, responsive to the application of the filter to the received presence-related data. The communications agent 608 transmits the generated message to a mobile device associated with the user.

In one embodiment, the at least one notification agent 602 is a notification agent 202 as described above in connection with FIGS. 2A-2D and FIG. 3. In another embodiment, the notification service 604 is a notification service 204 as described above in connection with FIGS. 2A-2D and FIG. 3. In still another embodiment, the presence agent 606 is a presence agent 206 as described above in connection with FIGS. 2A-2D and FIG. 3. In yet another embodiment, the communications agent 608 is a communications agent 208 as described above in connection with FIGS. 2A-2D and FIG. 3.

In some embodiments, the information repository is a personal information manager as described above. In other embodiments, however, the information repository is a website of any kind. In one of these embodiments, for example, when a new article is posted to a web site, or when contact information is added or modified in a customer relationship management system, or when a new or updated message is received for the user at a social networking site (including social book-marking and social event planning sites), the notification service 604 determines whether to notify the user of the update, responsive to presence-based filtering. In another of these embodiments, when a new article of interest to the user becomes available for sale on an electronic commerce site or becomes available for auction in an on-line auctioning system, or when the user receives an offer to buy an item the user made available for sale, the notification service 604 determines whether to notify the user of the update, responsive to presence-based filtering.

In other embodiments, the information repository does not have an Internet presence or a web-based user interface. In one of these embodiments, for example, the information repository is a back-end database not accessible via the Internet. In another of these embodiments, the information repository is a private corporate database. In still another of these embodiments, the information repository includes a back-end application executing on behalf of users in a private network. In some embodiments, the information repository stores data relating to the health of at least one network device. In one of these embodiments, the information repository may include a front-end health monitoring tool for use in accessing the information repository when managing and monitoring a network.

Referring now to FIG. 6, and in greater detail, the at least one notification agent 602 monitors at least one information repository identified by a user and receiving an identification of a modification to the at least one information repository. In one embodiment, the at least one notification agent 602 monitors a plurality of information repositories identified by a user. In another embodiment, the at least one notification agent 602 monitors at least one web-based information repository identified by a user. In still another embodiment, the at least one notification agent 602 monitors at least one corporate database identified by a user. In still even another embodiment, the at least one notification agent 602 monitors at least one private network identified by a user. In yet another embodiment, the at least one notification agent 602 monitors at least one social networking website identified by a user.

In one embodiment, the at least one notification agent 602 monitors at least one event planning website identified by a user. In another embodiment, the at least one notification agent 602 monitors at least one Really Simple Syndication feed associated with a website identified by a user. In still another embodiment, the at least one notification agent 602 monitors at least one web-based application identified by a user. In still even another embodiment, the at least one notification agent 602 monitors at least one web-based personal information manager identified by a user. In yet another embodiment, the at least one notification agent 602 monitors a web log displayed on the at least one website identified by a user.

The presence agent 606 provides presence-related data associated with the user. In one embodiment, the presence agent 606 includes a transceiver for requesting an activity status of a client machine associated with the user. In another embodiment, the presence agent 606 includes a transceiver for requesting a connectivity status of a client machine associated with the user. In still another embodiment, the presence agent 606 includes a transceiver for requesting an activity status of an instant messaging account associated with the user. In yet another embodiment, the presence agent 606 includes a transceiver for requesting a connectivity status of a mobile device associated with the user.

In one embodiment, the presence agent 606 includes means for identifying a time zone of a location in which the user is present at a time when the notification service receives the identification of the modification. In another embodiment, the presence agent 606 includes means for identifying a time of day at a location in which the user is present at a time when the notification service receives the identification of the modification. In still another embodiment, the presence agent 606 includes means for identifying an itinerary associated with the user at a time when the notification service receives the identification of the modification. In still even another embodiment, the presence agent 606 includes a global positioning system transceiver identifying a physical location of the user. In yet another embodiment, the presence agent 606 includes a localization-based system identifying a physical location of the mobile device associated with the user.

The notification service 604, in communication with the at least one notification agent and with the presence agent, applies a filter to the presence-related data and generates a message including the identification of the modification, responsive to the application of the filter to the received presence-related data.

In one embodiment, the notification service 604 includes a message generator creating a message for distribution via short message service. In another embodiment, the notification service 604 includes a message generator creating a message for distribution via flash short message service. In still another embodiment, the notification service 604 includes a message generator creating a message for distribution via multimedia message service. In yet another embodiment, the notification service 604 includes a message generator creating a message for distribution via server-alerted synchronization.

The communications agent 608 transmits the generated message to a mobile device associated with the user. In one embodiment, the communications agent 608 receives the generated message from the notification service 604. In one embodiment, the communications agent 608 receives the generated message from a message generator

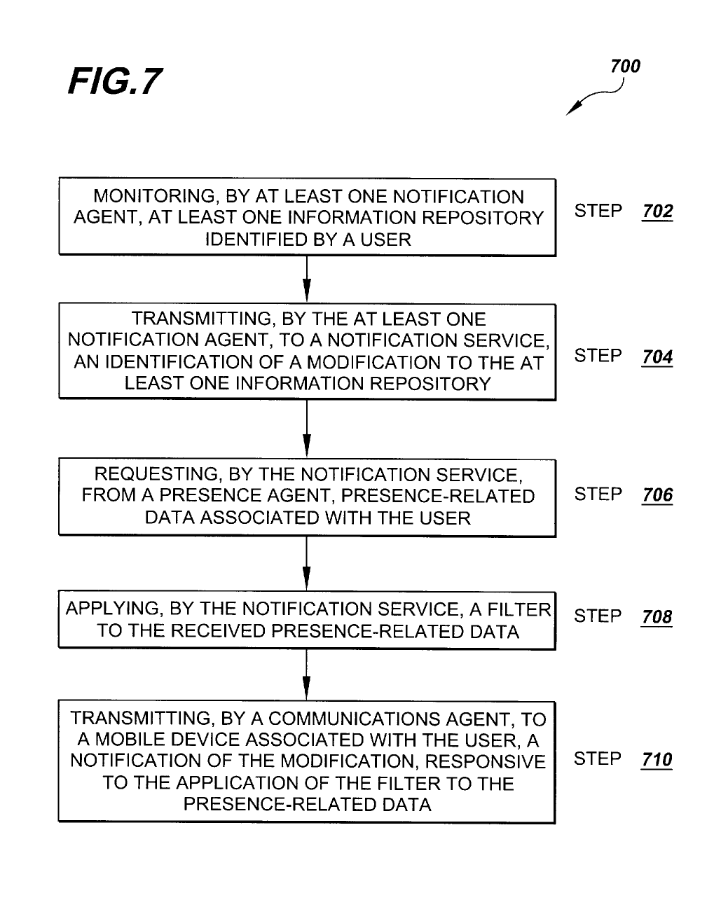

Referring now to FIG. 7, a flow diagram depicts one embodiment of the steps taken in a method for transmitting, to a mobile device, responsive to presence-based filtering, a notification of data received by at least one information repository identified by a user of the mobile device. In brief overview, the method 700 includes the step of monitoring, by at least one notification agent, at least one information repository identified by a user (step 702). The method includes the step of transmitting, by the at least one notification agent, to a notification service, an identification of a modification to the at least one information repository (step 704). The method includes the step of requesting, by the notification service, from a presence agent, presence-related data associated with the user (step 706). The method includes the step of applying, by the notification service, a filter to the received presence-related data (step 708). The method includes the step of transmitting, by a communications agent, to a mobile device associated with the user, a notification of the modification, responsive to the application of the filter to the presence-related data (step 710).

Referring now to FIG. 7, and in greater detail, monitoring, by at least one notification agent, at least one information repository identified by a user (step 702). In one embodiment, the at least one notification agent 602 monitors at least one web-based information repository. In another embodiment, the at least one notification agent 602 monitors at least one information repository that does not have an Internet presence or web-based interface. In some embodiments, the user accesses a graphical user interface to identify the at least one information repository. In other embodiments the user specifies a plurality of information repositories for monitoring. In still other embodiments, a separate notification agent 602 monitors each identified information repository. In yet other embodiments, a single notification agent 602 monitors all identified information repositories.

In one embodiment, the at least one notification agent 602 monitors a plurality of information repositories identified by a user. In another embodiment, the at least one notification agent 602 monitors at least one web-based information repository identified by a user. In still another embodiment, the at least one notification agent 602 monitors at least one corporate database identified by a user. In still even another embodiment, the at least one notification agent 602 monitors at least one private network identified by a user. In yet another embodiment, the at least one notification agent 602 monitors at least one web-based information repository identified by a user.

In one embodiment, the at least one notification agent 602 monitors at least one website identified by a user. In another embodiment, the at least one notification agent 602 monitors at least one social networking website identified by a user. In still another embodiment, the at least one notification agent 602 monitors at least one event planning website identified by a user. In still even another embodiment, the at least one notification agent 602 monitors at least one Really Simple Syndication feed associated with a website identified by a user.

In one embodiment, the at least one notification agent 602 monitors at least one web-based application identified by a user. In another embodiment, the at least one notification agent 602 monitors at least one web-based personal information manager identified by a user. In still another embodiment, the at least one agent 602 monitors a web log displayed on the at least one website identified by a user.

The at least one notification agent transmits, to a notification service, an identification of a modification to the at least one information repository (step 704). In some embodiments, the notification agent transmits, to the notification service, the identification as described above in connection with FIG. 3 (step 302). The notification service requests, from a presence agent, presence-related data associated with the user (step 706). In some embodiments, the notification service requests, from the presence agent, presence-related data as described above in connection with FIG. 3 (step 304). The notification service applies a filter to the received presence-related data (step 708). In some embodiments, the notification service applies a filter to the received presence-related data as described above in connection with FIG. 3 (step 306).

A communications agent transmits, to a mobile device associated with the user, a notification of the modification, responsive to the application of the filter to the presence-related data (step 710). In one embodiment, the communications agent 708 transmits, via short message service, the notification of the modification. In another embodiment, the communications agent 708 transmits a flash short message service text message. In still another embodiment, the communications agent 708 transmits a server-alerted synchronization message. In still even another embodiment, the communications agent 708 transmits, via multimedia message service, the notification of the selected identification of received event data. In yet another embodiment, the communications agent 708 formats the notification of the selected identification of received event data to comply with a display requirement of the mobile device.

The systems and methods described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, LISP, PERL, C, C++, C#, PROLOG, or any byte code language such as JAVA. The software programs may be stored on or in one or more articles of manufacture as object code.

Having described certain embodiments of methods and systems for transmitting, to a mobile device, a notification of newly-received personal information manager data associated with a user of the mobile device, responsive to presence-based filtering, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for transmitting, to a mobile device, a notification of newly-received personal information manager data associated with a user of the mobile device, responsive to presence-based filtering, the method comprising the steps of:
(a) transmitting, by a notification agent, to a notification service, an identification of data received for a user of a personal information manager;
(b) requesting, by the notification service, from a presence agent, presence-related data associated with the user;
(c) applying, by the notification service, a filter to the received presence-related data; and
(d) transmitting, by a communications agent, to a mobile device associated with the user, a notification of the receipt of data, responsive to the application of the filter to the presence-related data.

2. The method of claim 1 further comprising the step of receiving, by the notification agent, from the personal information manager, the identification of data received for the user.

3. The method of claim 1 further comprising the step of storing, by the notification agent, a copy of the received data.

4. The method of claim 1 further comprising the step of storing, by a storage element, a copy of the received data.

5. The method of claim 1 further comprising the step of storing, by a storage element, a copy of the identification of the received data.

6. The method of claim 1, wherein step (a) further comprises transmitting, by a notification agent, to a notification service, an identification of a type of data received for the user.

7. The method of claim 1, wherein step (b) further comprises requesting, by the notification service, from the presence agent, an indication of whether the user is connected to a client machine associated with the user.

8. The method of claim 1, wherein step (b) further comprises requesting, by the notification service, from the presence agent, an indication of a level of activity on a client machine associated with the user.

9. The method of claim 1, wherein step (b) further comprises requesting, by the notification service, from the presence agent, an indication of whether the user is connected to an instant messaging service.

10. The method of claim 1, wherein step (b) further comprises requesting, by the notification service, from the presence agent, an indication of a level of activity of the user on an instant messaging service.

11. The method of claim 1, wherein step (c) further comprises requesting, by the notification service, from the presence agent, an indication of a location in which the user is physically present.

12. The method of claim 1, wherein step (c) further comprises requesting, by the notification service, from the presence agent, an identification of a time zone of a location in which the user is present at a time when the notification service receives the identification of the received data.

13. The method of claim 1, wherein step (c) further comprises requesting, by the notification service, from the presence agent, an identification of a time of day at a location in which the user is present at a time when the notification service receives the identification of the received data.

14. The method of claim 1, wherein step (c) further comprises requesting, by the notification service, from the presence agent, an identification of an itinerary associated with the user at a time when the notification service receives the identification of the received data.

15. The method of claim 1, wherein step (b) further comprises requesting, by the notification service, from the presence agent, an indication of whether a mobile device associated with the user is connected to a network.

16. The method of claim 1, wherein step (d) comprises determining not to notify the user of the receipt of the identified data, responsive to the application of the filter to the presence-related data.

17. The method of claim 1, wherein step (d) further comprises transmitting, by the communications agent, via short message service, the notification of the receipt of data, responsive to the application of the filter to the presence-related data.

18. The method of claim 1, wherein step (d) further comprises transmitting, by the communications agent, a server-alerted synchronization message, responsive to the application of the filter to the presence-related data.

19. The method of claim 1, wherein step (d) further comprises transmitting, by the communications agent, via multimedia message service, the notification of the receipt of data, responsive to the application of the filter to the presence-related data.

20. The method of claim 1, wherein step (d) comprises transmitting, by the communications agent, the notification of the receipt of data, responsive to the application of the filter to the presence-related data, the notification formatted to comply with a display requirement of the mobile device.

21. A system for transmitting, to a mobile device, a notification of newly-received personal information manager data associated with a user of the mobile device, responsive to presence-based filtering, comprising:
a notification agent receiving an identification of data received for a user of a personal information manager;
a presence agent providing presence-related data associated with the user;
a notification service, in communication with the notification agent and with the presence agent, applying a filter to presence-related data and generating a message including the identification of the received data, responsive to the application of the filter to the received presence-related data; and
a communications agent transmitting the generated message to a mobile device associated with the user.

22. The system of claim 21 further comprising an event generator in communication with the notification agent and transmitting, to the notification service, the identification of received data.

23. The system of claim 21 further comprising a storage element storing a copy of the received data.

24. The system of claim 21 further comprising a storage element storing a copy of the identification of received data.

25. The system of claim 21, wherein the notification agent further comprises a receiver for receiving, from the personal information manager, the identification of the data received for the user.

26. The system of claim 21, wherein the notification agent further comprises a storage element storing a copy of the received data.

27. The system of claim 21, wherein the notification agent further comprises a transmitter for sending, to the notification service, an identification of a type of data received for the user.

28. The system of claim 21, wherein the presence agent further comprises a transceiver for requesting an activity status of a client machine associated with the user.

29. The system of claim 21, wherein the presence agent further comprises a transceiver for requesting a connectivity status of a client machine associated with the user.

30. The system of claim 21, wherein the presence agent further comprises a transceiver for requesting an activity status of an instant messaging account associated with the user

31. The system of claim 21, wherein the presence agent further comprises a transceiver for requesting a connectivity status of a mobile device associated with the user.

32. The system of claim 21, wherein the presence agent further comprises a global positioning system transceiver identifying a physical location of the user.

33. The system of claim 21, wherein the presence agent further comprises a localization-based system identifying a physical location of the mobile device associated with the user.

34. The system of claim 21, wherein the presence agent further comprises means for identifying a time zone of a location in which the user is present at a time when the notification service receives the identification of the received data.

35. The system of claim 21, wherein the presence agent further comprises means for identifying a time of day at a location in which the user is present at a time when the notification service receives the identification of the received data.

36. The system of claim 21, wherein the presence agent further comprises means for identifying an itinerary associated with the user at a time when the notification service receives the identification of the received data.

37. The system of claim 21, wherein the notification service further comprises a message generator creating a message for distribution via short message service.

38. The system of claim 21, wherein the notification service further comprises a message generator creating a message for distribution via multimedia message service.

39. The system of claim 21, wherein the communications agent further comprises a transmitter for sending, via short message service, the generated message to the mobile device.

40. The system of claim 21, wherein the communications agent further comprises a transmitter for sending, via multimedia message service, the generated message to the mobile device.

41. The system of claim 21 further comprising a wireless application protocol server transmitting a server-alerted synchronization message to the mobile device, responsive to the application of the filter to the presence-related data.
